(19) United States
(12) Patent Application Publication
(10) Pub. No.: US 2004/0073505 A1
(43) Pub. Date: Apr. 15, 2004

(54) Method for performing monte carlo risk analysis of business scenarios

(76) Inventor: James Foley Wright, Odessa, TX (US)

Correspondence Address: James F. Wright, 3000 Eastover Drive, Odessa, TX, 79762, US

(21) Appl. No.: 10/268,393

(22) Filed: Oct. 9, 2002

(51) Int. Cl. G06F 17/60

(52) U.S. Cl. 705/36

(57) ABSTRACT

The present invention uses Monte Carlo simulation techniques to evaluate the risk of business scenarios. A method of angular approximations (Gaussangular distributions™) is used to simulate symmetrical and unsymmetrical bell-shaped, triangular, and mesa-type distributions that fit data required by the metrics in the Monte Carlo calculation. The mathematical functionality of these Gaussangular distributions is comprised of their extremes, the most likely value, and a variable analogous to its standard deviation.

### REFERENCES CITED

### A. U.S. Patent Documents

| | | | |
|---|---|---|---|
| 6003018 | December 1999 | Michaud, et. al. | 705/36 |
| 6085175 | July 2000 | Gugel, et al. | 705/36. |
| 6167384 | December 2000 | Graff | 705/35; 705/1. |
| 6192347 | February 2001 | Graff | 705/36; 705/31; |
| | | | 705/35; 705/38. |
| 6240399 | May 2001 | Frank | 705/36 |
| 6275814 | August 2001 | Giansante, et al. | 705/36; |
| | | | 705/35. |
| 6278981 | August 2001 | Dembo, et al. | 705/36. |
| 6321212 | November 2001 | Lange | 705/37; 705/1; |
| | | | 705/35; 705/36; |
| | | | 705/38. |

### B. Other References

James F. Wright, “Monte Carlo Risk Analysis of New Business Ventures”, (New York City: AMACOM, 2002).

Milton Abramowitz and Irene A. Stegun, eds., “Handbook of Mathematical Functions with Formulas, Graphs and Mathematical Tables” (Washington, D.C.: National Bureau of Standards, U.S. Department of Commerce, 1970), pp 925-995.

George S. Fishman, “Monte Carlo Concepts, Algorithms, and Applications” (New York: Springer Verlag, 1995).

### STATEMENT OF FEDERALLY SPONSORED PARTICIPATION

Not Applicable

### REFERENCE TO CD-ROM APPENDIX

An Excel worksheet with a working embodiment of the present invention (in the form of a Visual Basic Macro) is provided on the attached CD-ROM. This CD-ROM includes an “Input” worksheet, “Output” worksheet, and a listing of the Visual Basic Source code. The program is started by:

1) Loading the CD into your CD drive and waiting for it to automatically load the Input worksheet of MCGRA.xls. If this does not occur, load Excel and then navigate to the CD and execute MCGRA.xls from the MCGRAExcel directory. The Macro must be enables in order to run the program.

2) When MCGRA.xls loads, it should take you to the top of the worksheet labeled Input. Pressing the Ctrl-Shift-M keys simultaneously will start the execution of the Visual Basic Macro for Excel, which is a working embodiment of the present invention. The progress of the calculation is shown in cell J:4. When the calculation is completed (50,000 iterations) you will be automatically taken to the Output worksheet.

3) The Visual Basic source code can be examined by navigating by way of “Tools”→“Macro”→“Visual Basic Editor” and then opening the “MCGRA” module in the “MCGRA.xls” file.

### BACKGROUND OF THE INVENTION

The process of accurately and precisely determining the realistic risk of business scenarios has been a source of concern and study since the advent of commerce and currency. These scenarios include the future performance of new business ventures and the future operations of current businesses. It is recognized that the uncertainty in the future performance of these scenarios is due to the cumulative effects of the uncertainties in the various inputs to the business models. In other words, uncertainties in the profit for a business venture are driven by the uncertainties in the product sales prices and total production costs, plus the increased uncertainties of the year-by-year calculated projections as we move into the future. Even though Monte Carlo methods have been used to evaluate real property allocation optimization, trading optimization and security portfolio optimization, it has always proved too cumbersome to be used to evaluate the risk of business ventures as described in business plans.

To further understand the concept of quantitative risk analysis, the two terms precision and accuracy need to be defined since they are fundamental to the process. Consider the case where a marksman is to take three shots at a 1-inch diameter bull's eye target that is in the center of a 12 inch by 12 inch piece of paper. The grouping would be defined as precise but not accurate if the pattern of the three shots form an equilateral triangle that is 1 inch on each side and the center of which is 9 inches from the bulls eye. If the three shots formed an equilateral triangle that is 6 inches on each side and centered on the bulls eye, the grouping would be accurate but not precise. It is apparent that the ideal scenario should be both accurate and precise.

The total error of a system is due to both its random error and uncertainty. I define the random error as solely an effect of chance and a function only of the physical system being analyzed. Further, random errors of a system are not reducible through either further study or by further measurement. In fact, there are random errors in every physical system and the only way that they may be altered is by changing the system itself. The random error will always effect the preciseness of a parameter but not its accuracy.

I define the uncertainty of any system to be due simply to the assessor's lack of knowledge about the system being studied. Either further measurements or study may reduce the uncertainty of a system and it is therefore subjective in nature. This subjectiveness comes from the fact that this uncertainty is a function of the assessor, and their knowledge (or lack thereof) about the system. However, there are methods available that allow these assessors to become more objectively subjective. These methods include the systematic assessment of quantitative information contained in the available data about model parameters. The result is an uncertainty analysis that any knowledgeable person using systematic methods should agree with, given the available information. It should be noted that changes in the uncertainty of a parameter could change its most likely value and therefore effects its accuracy.

Now that both components (the random error and uncertainty) of the total error of a system are defined it can be seen that in business ventures it is important to have realistic models where first and foremost the uncertainty should be minimized. However, the random error must never be neglected.

One of the best ways we have to ensure that input data to a model is realistic is to ensure that it is as accurate and precise as possible. By making the data both accurate and precise the investor or shareholder will receive the quality of information sufficient to help them make knowledgeable business decisions.

A pro forma has historically been recognized as the method-of-choice to determine a business scenario's future worth and it is usually calculated using the so-called “best values” for its inputs. However, since this pro forma is a projection of future activities that will be affected by yet unknown forces, or uncertainties, it is realized that using the currently perceived “best values” as input may not yield the most realistic projections of future activities. The influence of these uncertainties in the model's final results are sometimes estimated by playing “what if” or “worst case/best case” games where the pro forma is recalculated under different scenarios. However, this methodology provides the analyst with no real measure of preference of any of the individual pro forma when compared to the others and the result is just a series of disjointed calculations with minimal relative significance.

Differential calculus is one method that may be used to estimate how uncertainty is propagated from input data to a pro forma but this is fraught with disadvantages. The error, or uncertainty, calculated for the pro forma using the standard adaptation of this method is single valued, symmetrical, and therefore most likely unrealistic. Further this calculation is usually erroneously simplified by ignoring all cross terms in the expansion of the error differential because of the “assumed” symmetry in the error, or uncertainty, of each of the input variables. Even if the errors in all input vales were truly symmetric, this methodology may still be problematic because of the difficulty in obtaining the required differential in a closed form that is easy to use.

Many currently used stochastic models are also hampered by the use of distribution functions (usually triangular or Gaussian) that are “easy to use” in the calculations but do not realistically represent the input data. As will be shown later, the shape of distributions representing business data used in these analyses is generally bell-shaped, but unsymmetrical.

Triangular distributions are those that represent frequency distributions with a triangle that may or may not be equilateral. Triangular distributions are easy to use because they can be unsymmetrical and are quick to compute. However, representing business data with them lacks precision when compared to bell-shaped distributions.

Data that has a true Gaussian character comes from a large variety of “natural” and “unbiased” data including physical measurements and biological data. This Gaussian distribution is mathematically defined from −∞ to +∞, and has the familiar symmetrical bell shape. Its most likely value is at the center of the distribution and there are many values near the most likely value that are also very likely. The least likely values are at the extremes of the distribution and many values near these extremes are also very unlikely to occur.

The Gaussian's symmetrical distribution generally allows a more precise, yet less accurate, representation of business data than the triangular distribution. Further, the Gaussian distribution cannot be integrated in a mathematically closed form and therefore must be solved using tables, which makes it more difficult to use, slow to compute, and open to errors caused by tabular interpolation.

When you examine frequency distributions from “real” business data it is immediately obvious that it is generally bell-shaped and unsymmetrical. Therefore either Gaussian or triangular distributions cannot realistically represent this data. With a little thought it can be ascertained that the skewness, or lack of symmetry, of business data is usual and predictable. Distributions of cost values will generally be skewed to the high side and distributions of incomes will be skewed to the low side. This becomes intuitive when one considers that if something unexpectedly goes wrong in any cost-determining scenario (causing an uncertainty), the most likely result will be to raise the cost rather than lower it. The converse is true with the income.

Further, the art of projecting business data into the future using today's information is commonly used in calculating pro forma but it is a tremendously risky business that currently ranges from being difficult to impossible. We know that data we collect today is valid for today and data that was collected last year was valid for last year. However, in scenarios that project economic data into the future the analysts must take this known data and accurately and precisely project it into the future years of the pro forma.

Despite this increased utilization of PC's (personal computers) in business, an easy to use software package that can accurately and precisely calculate the risk that a business venture will obtain a certain rate of future performance based on realistic input data has not surfaced.

### BRIEF SUMMARY OF THE INVENTION

The present invention is directed to performing Monte Carlo risk analysis of business scenarios using angular approximations to represent the input data for a variety of metrics, which are the mathematical representations of the scenario. I call these angular approximations Gaussangular distributions™. The Monte Carlo risk analysis used in this invention is an operational blend of Monte Carlo simulation and quantitative risk analysis procedures as embodied in a software system named MCGRA™(Monte Carlo Gaussangular Risk Analysis). This software system is uniquely designed to quantify, both accurately and precisely, the risk that certain future performance criteria specified by the metric and its input data will be met in various business scenarios.

The phrase “Monte Carlo” was the coded description given to the then classified process of Monte Carlo simulation as it was used in the early 1940's to help develop the U.S. atom bomb. This phrase was most likely whimsically selected because it is also the location of where other probabilistic events occur—the famous Casino in the Mediterranean Principality of Monaco. However, the use of the name Monte Carlo does not mean to imply that the method is, in any sense, either a gamble or risky. It simply refers to the manner in which individual numbers are selected from valid representative collections of input data so they can be used in an iterative calculation process. These representative collections of data are typically called probability distribution functions, or just distribution functions, for short.

Monte Carlo simulation methods are primarily used in situations where:

1. The input data has uncertainties that can be quantified;

2. The answer, or output, must represent the most likely values of the input data;

3. The calculated uncertainty in the answer, or output, must accurately reflect the uncertainty in the Input data; and

4. The calculated uncertainty in the answer, or output, must be an accurate measure of the validity of the model.

The Monte Carlo simulation method, in one form or another, has been successfully used in scientific applications for about 70 years. The technique remains a cornerstone of US programs involving Nuclear Weapon Design, NASA (Space) Projects, and the solution of other basic and applied scientific and engineering programs across the world.

Monte Carlo simulation accurately and precisely models any scenario as long as:

1. The metric is realistic.

2. The distribution functions used to model the input parameters are realistic.

3. The technical elements of the software are correct.

4. There is sufficient computer hardware power to run the problem.

If the “answer” to the model is not realistic, then at least one of the four above-mentioned requirements has not been met.

In order to analyze a scenario, a model must first be constructed that will realistically represent the scenario. Historically, a pro forma has been the preferred model to evaluate the future performance of a business scenario. An accurate and precise representation of the future performance of an existing company, or a new investment, or a portfolio can be calculated if the following are used.

1. Calculational methodology, or engine, that accurately and precisely shows the effects of input uncertainty in the final “answer” (Monte Carlo simulation)

2. Realistic input data (in the form of Gaussangular distributions)

3. Realistic metric (profitability index, etc.)

4. Effective software (such as embodied in this invention) for the computer being used

This calculated representation of the future performance, as embodied in this invention, is in the form of a probability distribution and can therefore be used to predict how the uncertainty of all of the input data quantitatively affects the final pro forma.

Monte Carlo simulation (see FIG. 1) is an iterative process that requires a distribution function for each input variable of the metric to be modeled. It is important that each of these distribution functions is realistic so that they accurately and precisely represent the input variables. In each iteration a representative answer for the metric is calculated using a new set of weighted values for each of the input variables. Each of these weighted values for a variable is obtained from their respective distribution functions using a new PRN (pseudo random number). It then places this representative answer into the proper bin of a frequency histogram of possible answers (called the metric histogram). It repeats this process for tens of thousands of iterations; each time obtaining a new freshly weighted value for each input variable, calculating a new representative answer, and then placing this new answer in the proper bin of the frequency histogram. The end result of this process is a frequency distribution of representative answers that reflects the individual distributions of the input variables with their respective uncertainties. Therefore, this methodology directly provides a distribution of answers that reflects the uncertainty of each and all of our input variables!

Further since our answers are in the format of a frequency distribution several important values can be produced that will help assess the risk of the project.

1. Most likely value of the answer.

2. Average (or mean) value of the answer.

3. The values that bound the central-most 95% (or any other percentage) values of the answer.

4. The probability that the answer will be either less than or greater than a particular value.

All of these data are important for the analyst to use in order to determine the quantitative risk of the project. Therefore, the process of this invention is called Monte Carlo risk analysis.

As has been previously noted, the distribution of economic data are generally skewed, or unsymmetrical, and also have Gaussian-like characteristic that cause their standard deviation to increase as its uncertainty increases. Therefore this invention includes the use of the Gaussangular distribution™ that has the following properties.

1. It can be either skewed, or symmetrical.

2. It is defined by a parameter that is analogous to the square of its second central moment, which is commonly called the standard deviation.

3. It provides realistic, precise, and accurate representations of economic data.

4. It is extremely fast to calculate in small digital computers (PC's).

The Gaussangular distribution is therefore superior to both the triangular and Gaussian distributions and is an important part of this invention.

One of the advantages of the Monte Carlo risk analysis process is that the analysts can use any metric as long as it provides results that are realistic, accurate and precise. The conventional pro forma metrics fit this requirement for one embodiment of this invention and the inventor routinely uses before-tax profit, after-tax cash flow, and the profitability index for the evaluation of many business scenarios.

### BRIEF DESCRIPTION OF THE SEVERAL VIEWS OF THE DRAWINGS

The invention is illustrated in the accompanying drawings in which:

FIG. 1 is a schematic block diagram of the Monte Carlo simulation process and it shows (progressing from left to right) the calculated distributions of the input variables “feeding” the Monte Carlo simulation engine to provide the calculated output histogram.

FIG. 2 is a table that outlines the steps of the Monte Carlo risk analysis process.

FIG. 3 is a graph of a representative Gaussian probability distribution function, or PDF.

FIG. 4 is a graph of a representative Gaussian cumulative distribution function, or CDF, which is the normalized integral of the PDF.

FIG. 5 is a graph of Gaussian distribution functions where each has a different standard deviation.

FIG. 6 is a schematic diagram of a symmetrical Gaussangular distribution™ function with two break points.

FIG. 7 is a graph of symmetrical Gaussangular distribution functions where each has a different value of the Gaussangular distribution parameter A₂.

FIG. 8 compares a Gaussian distribution with a symmetrical Gaussangular distribution as used in this software.

FIG. 9 is a schematic diagram of an unsymmetrical triangular distribution.

FIG. 10 is a schematic diagram of an unsymmetrical Gaussangular distribution function with two break points.

FIG. 11 is a schematic diagram of an unsymmetrical Gaussangular distribution function with four break points.

FIG. 12 is a logic flow chart of the Monte Carlo computer software (MCGRA™).

### DETAILED DESCRIPTION OF THE INVENTION

The Monte Carlo risk analyses of business scenarios in this invention are accomplished by combining the Monte Carlo simulation process with conventional quantitative risk analysis methods. The results calculated using this Monte Carlo risk analysis provide a realistic risk assessment if the metric is a realistic model for the scenario being evaluated and the distribution function representing the input data is realistic. The term realistic is used to describe the model and input data because the end result of the process is a prediction and at best it can only be realistic and not precise or accurate. However, it is important to note that the Monte Carlo simulation process will certainly provide an accurate and precise mapping of the uncertainties in the input distributions to the output distribution.

The quantitative risk analysis part of this invention involves using metrics and input data distributions that are realistic so that the end result of the Monte Carlo simulation will provide data from which risk-related information from the metric can be extracted. This risk-related information includes the most likely and mean values, the standard deviation, and probabilities that economic goals related to the metric will occur.

The description of this invention will first discuss the Monte Carlo method, then the important Gaussangular distribution functions, and finally how the software implements the entire risk analysis process.

### A. The Monte Carlo Method

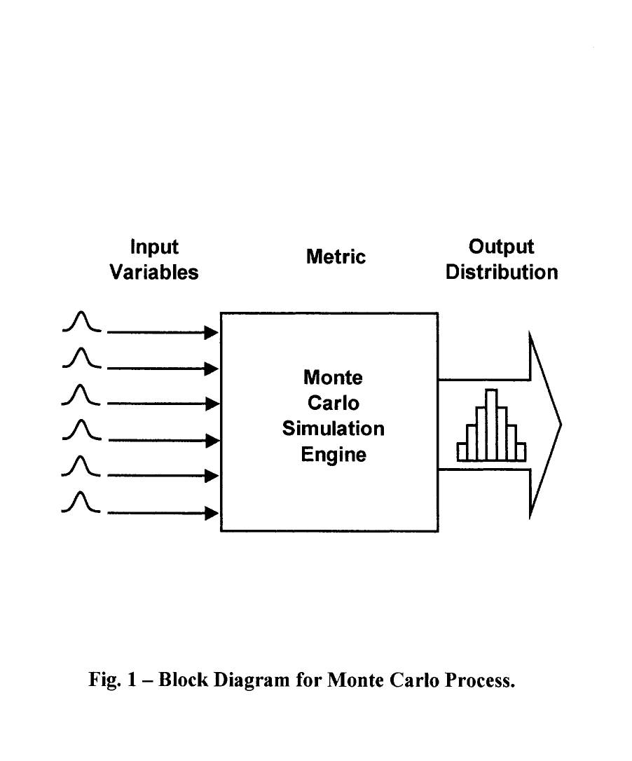

The block diagram in FIG. 1 schematically represents the Monte Carlo simulation process. The key components of the process are the metric, how the metric is calculated, and how the “answer” to the metric is determined. The arrows on the left side of the box labeled “Monte Carlo Simulation Engine” in FIG. 1 represent the input to the simulation. The small “bell-shaped” curves shown to the left of each of the input arrows are reminders that distributions for each variable are the required input rather than single “best values” that have been historically used in non-stochastic modeling. The histogram in the large output arrow to the right of the box labeled “Monte Carlo Simulation Engine” in FIG. 1 is a reminder that its output is not just a single answer but is a calculated frequency distribution in the form of a histogram. This histogram will be converted to a discrete distribution function at the end of the iteration process so a thorough probabilistic analysis can be performed on the scenario as part of the risk analysis process.

In summary, the Monte Carlo simulation engine calculates the output discrete distribution function such that it accurately and precisely reflects the uncertainty of all of the input variables as applied to the particular metric that was used in the analysis. Therefore, if the input distributions and the metric are realistic, the output distribution will also be realistic. Further, since the output is a distribution, this process will not only provide the mean, most likely, and standard deviation values of the metric, but also probabilities that the metric will have values of at least certain values. Therefore if the distribution representing the input variables and the metric are all realistic, the calculated discrete distribution will be realistic and can be used to provide different measures of the risk for the venture.

### A.1. The Monte Carlo Risk Analysis Process

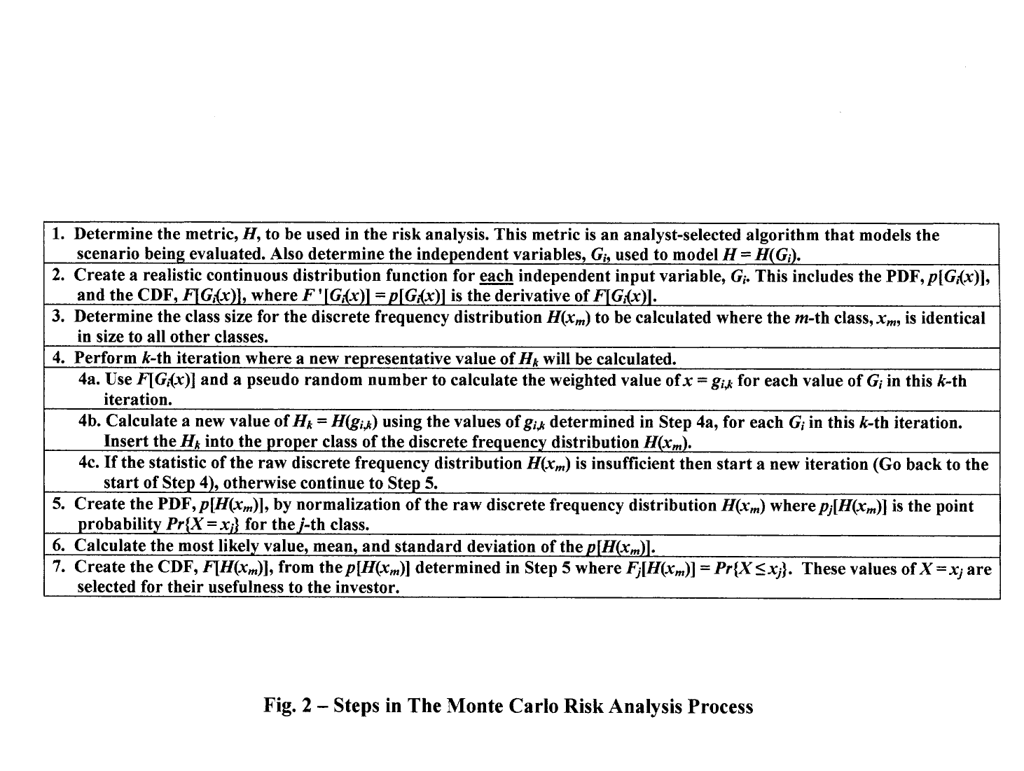

Monte Carlo risk analysis can more exactly be defined as a stochastic, static simulation that uses continuous distributions as input. The Monte Carlo risk analysis process is briefly summarized in the Table depicted in FIG. 2, which will further define this invention.

### Step 1 of Table in FIG. 2

The metric used to evaluate the economic scenario is defined in this step. This metric, H, can be any algorithm, or equation, that realistically models the system being evaluated. For many business ventures this metric could be a pro forma calculation of the before tax profit, the after tax cash flow, the profitability index, etc. It is important to remember that the analyst ultimately selects the metric used in this invention! And the metric selected should be one that realistically models the system being studied and is one with which the analyst is familiar. Equation (1) defines the equation by which this metric, H, is calculated as a function of each of the independent input variables, Gᵢ.

H=H(Gᵢ) (1)

Before the model defined by Equation (1) can be used, it must be determined that distribution functions for each of the input variables, Gᵢ, are readily determinable. By this I mean that their distributions can be either obtained from data, calculated, or otherwise determined.

### Step 2 of Table in FIG. 2

Of course in this paradigm, the individual input variables, Gᵢ, are not single values but are probability distributions functions. Therefore, the first step in this process is to make certain that the individual distributions for each input variable, Gᵢ, can be created that are realistic.

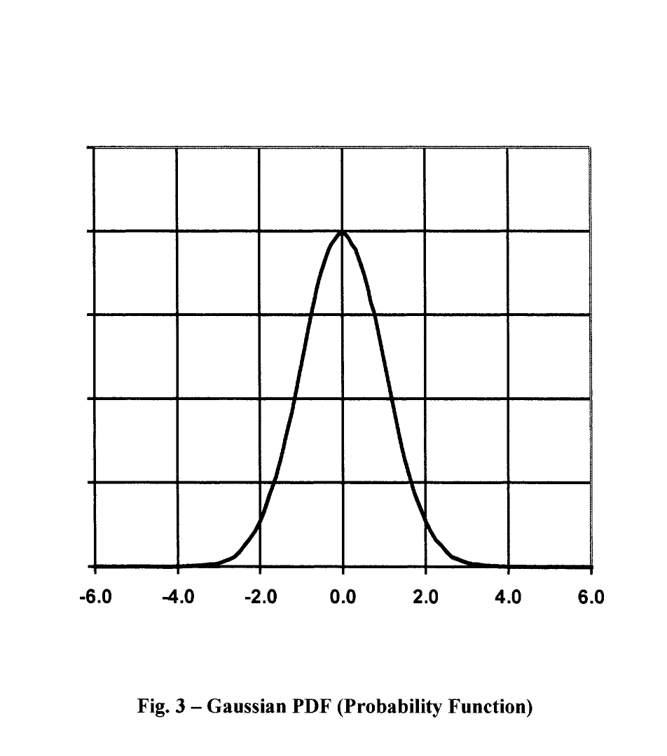

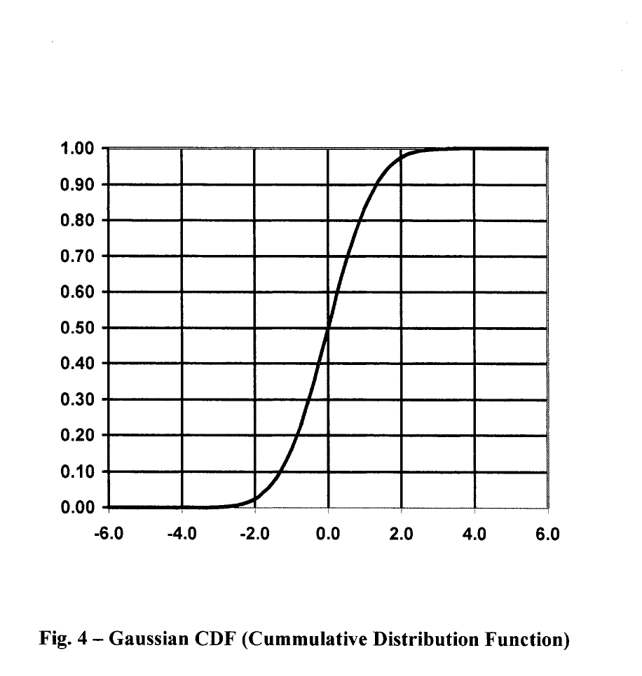

Even though these distribution functions are the PDF (probability distribution function), p[Gᵢ(x)], that may be represented by a Gaussian distribution schematically shown in FIG. 3, they are not specifically known in advance. The PDF is usually an analytical function that can be fit to the data in a curve-fitting process. However, in order to use a distribution in a Monte Carlo calculation the associated CDF (cumulative distribution function) as shown in FIG. 4 must be known. The CDF, F[Gᵢ(x)], is related to the PDF as defined in Equation 2.

F[Gᵢ(x)]=∫p[Gᵢ(x)]dx (2)

Conversely, the PDF is actually the first derivative of the CDF as shown in Equation (3).

$$\frac{ⅆ}{ⅆ x} F [ {G}_{i} ( x ) ] = p [ {G}_{i} ( x ) ] \qquad ( 3 )$$

In this invention, the input data can best be realistically represented by the Gaussangular distribution that will be discussed in detail in Part B, below. The Gaussangular distribution is more precise, accurate, and therefore more realistic than other distributions that are commonly used in Monte Carlo Calculations on a PC (personal computer).

### Step 3 of Table in FIG. 2

In this Monte Carlo risk analysis process, a new value of the metric, H=Hₖ, will be calculated in each k-th iteration. This collection of {Hₖ} values are classified and placed into a histogram that represents a discrete frequency distribution with m classes defined as H(xₘ). When enough iterations have been run so that the frequency distribution is sufficiently defined for the purposes of this risk analysis, the H(xₘ) will be normalized to create the PDF. Further, since the maximum domain size for the H(xₘ) is the same as for the PDF, the size of the m classes can now be determined.

The number of classes that seem to be sufficient in most cases is between 30 and 40. Most statistical texts would state that 10 to 15 classes are better because of the difficulty in adequately filling the 30 to 40 classes. However since tens of thousands of iterations are routinely performed in this embodiment of the invention this argument is not valid. Therefore 50 classes are used to ensure that sufficient detail exists in the structure of the frequency distribution near the most likely value and out to a distance of at least ±4σ.

Since a histogram will be required for each metric for each year, the absolute worst- and best-case values are calculated as the theoretical domain of the distribution H(xₘ) by using the extreme values of each and every input variable. Therefore, the class size is calculated by dividing this theoretical domain by 50. The minimum class, or bin, will start at the worst-case value and end at this worst case value plus the class size.

### Step 4 of Table in FIG. 2

This is the iteration process and includes Steps 4a, 4b and 4c. The goal of the iteration process is to ultimately calculate a sufficiently large number of values of the Hₖ so that the histogram H(xₘ) is useful in determining the risk of the scenario being analyzed.

### Step 4a of Table in FIG. 2

In order to calculate a representative value of Hₖ in the k-th iteration, a weighted value g_{i,k} must be determined for each independent variable Gᵢ in the metric. This is accomplished by using the following methodology.

First, since each p[Gᵢ(x)] is normalized the CDF is also normalized and the 0≦F[Gᵢ(x)]≦1. Therefore, the first step in this iterative process is to use a PRN between 0 and 1 to calculate a weighted value, g_{i,k}, from the distribution F[Gᵢ(x)]. Equation (4) describes this procedure.

$$F [ {G}_{i} ( {g}_{i , k} ) ] = Pr \{ x \leq {g}_{i , k} \} = {\int }_{{x}_{min}}^{{g}_{i , k}} p [ {G}_{i} ( t ) ] ⅆ t \qquad ( 4 )$$

This process is accomplished by setting Pr{x≦g_{i,k}}=PRN, integrating the definite integral of Equation (4), and then solving the resulting equation for g_{i,k}. This g_{i,k} is the weighted value of the variable Gᵢ that is used in the k-th iteration to calculate the Hₖ.

If this process of obtaining weighted values of g_{i,k} is repeated an infinite number of times the collection of all of the values of g_{i,k} for a particular variable Gᵢ would reproduce the distribution p[Gᵢ(x)]. This defines the g_{i,k} as being a weighted value.

### Step 4b of Table in FIG. 2

Once these values of g_{i,k} in Equation (4) are determined for each Gᵢ(x) in this k-th iteration, the Monte Carlo engine calculates a new representative value of the metric, Hₖ=H(g_{i,k}). After Hₖ is calculated the boundaries of the classes of the histogram are searched to determine where this Hₖ belongs. Finally, the class frequency in which the value of Hₖ belongs is then incremented by one.

### Step 4c of Table in FIG. 2

After this value of Hₖ is determined and classified, it must be determined if the newly calculated frequency distribution H(xₘ), is sufficient or if more iterations are required. If more iterations are required, the program will return to Step 4a of this Table to start another iteration. If no more iterations are required, the program will move to Step 5.

There are several potential tests that may be run to check the statistic of H(xₘ). The most obvious test is to check the current most likely value of the PDF, p[H(x)], to see if it is equal (within some number of significant figures) to a baseline calculation of Hₒ. Where, Hₒ is calculated from Equation (1) using the most likely values of each of distribution functions for the input variables, Gᵢ. Another potential test is the degree of smoothness of the new distribution, p[H(x)]. This inventor uses years of experience with Monte Carlo simulation with these metrics and Gaussangular distributions to know that generally 5,000 to 10,000 iterations is usually sufficient. However, since the process is so quick to run on a PC, the inventor runs 50,000 iterations for every problem and then checks the printed output to ensure that the distributions are smoothly changing.

### Step 5 of Table in FIG. 2

Since the H(xₘ) is a calculated frequency distribution, this invention does not attempt to fit it to a predetermined distribution function. Instead it will be converted to a discrete probability distribution function.

Consider that we have a frequency distribution, H(xₘ), characterized by the random variable x taking on an enumerable number (m=50 in this case) of values {x₁, x₂, x₃, . . . , xₘ} with corresponding point frequencies, {h(x₁), h(x₂), h(x₃), . . . , h(xₘ)}). If the sum of the corresponding frequencies are normalized, they will each become point probabilities, {p₁[H(xₘ)], p₂[H(xₘ)], p₃[H(xₘ)], . . . , pₘ[H(xₘ)]} as defined in Equation (5).

pⱼ[H(xₘ)]=Pr{X=xⱼ}≧0 (5)

Where, Equation (5) is subject to the normalization mentioned above and shown by Equation (6).

$${\sum }_{k = 1}^{m} {p}_{k} [ H ( {x}_{m} ) ] = 1 \qquad ( 6 )$$

With the normalization of Equation (6) the H(xₘ) is now the PDF for a discrete probability distribution.

As can be seen by the definition above, we have m classes in this PDF. The set {xᵢ} of values for which the corresponding values of pᵢ[H(xₘ)]>0 is termed the domain of the random variable x.

### Step 6 of Table in FIG. 2

Once the point probability, pⱼ[H(xₘ)], is created, a most likely value of the metric, H(xₘ), can be easily determined. The most likely value of the newly calculated distribution is easy to recognize as it the value of xⱼ where pⱼ[H(xₘ)] is at a maximum.

The statistical mean value of the PDF is calculated using Equation (7).

$$m = {\sum }_{j = 1}^{m} {x}_{j} {p}_{j} [ H ( {x}_{m} ) ] \qquad ( 7 )$$

where the sum is over the m=50 classes.

When citing the most likely and mean values of the distribution, it customary to also quote the Standard Deviation, σ, to provide a measure of the uncertainty in the distribution. The Standard Deviation is given by Equation (8).

$$σ = \sqrt{{\sum }_{j = 1}^{m} {( {x}_{j} - m )}^{2} {p}_{j} [ H ( {x}_{m} ) ]} \qquad ( 8 )$$

### Step 7 of Table in FIG. 2

Lastly, this invention allows the calculation of several discrete probabilities using Equation (9) to calculate the Pr{x≦xₙ}.

$$\begin{matrix}{F}_{n} [ H ( {x}_{m} ) ] = Pr \{ X \leq {x}_{n} \} = {\sum }_{k = 1}^{n} {p}_{k} [ H ( {x}_{m} ) ] & & n \leq m\end{matrix} \qquad ( 9 )$$

The embodiment of this invention in the computer system MCGRA selects three values of xₙ that produce meaningful probabilities that are useful to the analysts. These are the xₙ for Pr{x≦xₙ}<0.9, 0.6, and 0.4. However, other values can be determined in this embodiment since the data for the CDF is given in tabular form in the output. This completes the Monte Carlo Risk Analysis process.

Now that the Monte Carlo risk analysis process has been described in some detail, a few of the more important elements are further described below. These include, the metric, representing input variables as distributions, and the importance of pseudo random number generators.

### A.2. The Metric

As was previously stated, this invention has several embodiments that are differentiated from each other by their metrics. One of the principle advantages of this invention is that any metric can be used as long as it realistically defines the scenario under study and the metric uses data that can be represented by a realistic distribution of some kind. In fact, one of the most significant advantages of this invention is that Monte Carlo risk analysis can now be applied to systems using metrics that have been historically used in non-stochastic analyses and that are familiar to those in the world of business. These familiar metrics include calculating the pro forma that use before-tax profit, after tax cash flow, present values of cash flows, and the profitability index. In addition, it can also be immediately used in scenarios where new metrics are derived for special purposes. The only requirements are that the metric is realistic and its input data can be represented by some sort of a distribution function.

### A.3. Input Values as Distribution Functions

The advantage that distribution functions have over either best values or best values with single errors is that they are much more realistic. Consider the case where a particular widget is required in the manufacturing process for a product that Company A is manufacturing. If 500 vendors were called about their selling price of a widget to Company A, and the results put into a frequency distribution, this distribution would most certainly be bell-shaped and skewed. Now that Company A's costs for this widget are known for this year, the costs can be projected for each of the next five years. One thing is for sure and that is the uncertainty in the widget costs will increase each year in the future even though the most likely cost may decrease or increase as a function of the volume Company A will use in future years. Another thing to remember is that there are always more unknown factors that can raise the cost of these widgets in the future than lower the cost. Therefore, the distribution functions for these costs must have the following characteristics.

1. The difference between |(most likely cost)−(minimum cost)|<|(maximum cost)−(most likely cost)| the year the data is taken and this difference will increase each year into the future.

2. The effective standard deviation will increase each year into the future. Therefore, a considerable amount of flexibility is required for the distributions that represent business data.

However, seldom are there 500 vendors available for price quotes. In general, you will have three to five and maybe only one. Therefore this invention uses a process of obtaining the absolute minimum value, the most likely value, and the absolute maximum value as a starting place. If there is only one vendor you can still get these numbers from the single vendor based on the quantity purchased. The next parameter to consider is the standard deviation, or uncertainty in the distribution. The symmetrical Gaussian distribution has its standard deviation, 4r, as one of its defining independent functional variables. No such relationship exists for triangular distributions as they are generally used in Monte Carlo applications.

The importance of the distribution that is used to represent the input data is of paramount importance. In Part B it will be shown that the Gaussangular distribution used in this invention not only has an effective standard deviation it also has the flexibility to provide an accurate and precise representation of the available input data for the metric. The old adage of “Garbage In, Garbage Out” is true and important.

### A.4. PRN's (Pseudo Random Numbers)

Another topic that is extremely important in the Monte Carlo simulation process is the selection of the pseudo random numbers. In Step 4a of the Table in FIG. 2, it was mentioned that a pseudo random number is used to select a weighted value of each input variable. First, the term pseudo random number is a statement of philosophy as it would be impossible to generate a completely random number with the ordered (non-random!) logic of a computer program.

Much has been written about the statistical tests that can be used to verify the randomness of a specific PRN. The ideal characteristics of pseudo random numbers are:

1. They must be uniformly distributed numbers over the domain of 0≦x≦1,

2. They must be statistically independent,

3. Any set must be reproducible,

4. Their generation must use a minimal amount of computer memory, and

5. They must be generated quickly in a digital computer.

Even though the implementation of these five requirements usually involves a degree of compromise, most PRN generators utilize a type of congruential methodology where the compromise is minimized. This invention uses a PRN generator which was first published by Fishman that utilizes the congruential methodology and whose n vs. (n+1), n vs. (n+2), and n vs. (n+3) scatter diagrams have been examined and deemed suitable by the inventor.

### B. Gaussangular Distribution Functions

This invention uses the Gaussangular distribution function that is a hybrid that closely approximates bell-shaped distributions, like the Gaussian or other normal distributions, with a series of straight-line segments. Several of its unique and useful characteristics are listed below.

1. It has a characteristic called the Gaussangular deviation, 1/A₂ that is analogous to the square of the second central moment of the distribution, or standard deviation.

2. By changing this A₂, the Gaussangular represents triangular and Mesa-type distributions.

3. It can represent unsymmetrical distributions as well as symmetrical ones.

4. It is quick to calculate.

5. It is easy to use.

Before discussing Gaussangular distributions, the general characteristics of Gaussian distributions must first be developed and discussed.

### B. 1. Gaussian Distribution

The Gaussian distribution is a generally bell-shaped distribution that has a single central peak, is normalized, and is symmetric about the central peak. The probability density function, or PDF, of a Gaussian distribution is shown in FIG. 3 and defined by Equation (10).

$$p ( x ) = \frac{1}{σ \sqrt{2 π}} exp [ \frac{- {( x - m )}^{2}}{2 {σ}^{2}} ] \qquad ( 10 )$$

where m is the mean value of the distribution, σ is its standard deviation, and exp(x)≡e^{x}. It should be noted that in a symmetrical distribution such as the Gaussian the mean value is the most likely value.

A PDF, p(x), is said to be normalized if it satisfies Equation (11).

∫p(t)dt=1 (11)

The cumulative distribution function, CDF, of a Gaussian distribution is shown in FIG. 4 and defined by Equations (12) and (13) where the CDF is F(x) which has the PDF, p(x), as its first derivative.

$$\frac{ⅆ F ( x )}{ⅆ x} = p ( x ) \qquad ( 12 )$$

and

$$F ( x ) = Pr \{ X \leq x \} = {\int }_{- ∞}^{x} p ( t ) ⅆ t \qquad ( 13 )$$

where Pr{X≦x} is the probability that X≦x.

As can be seen from Equation (10), the constants that determine the shape of a Gaussian distribution are its mean value, m, and its standard deviation, σ.

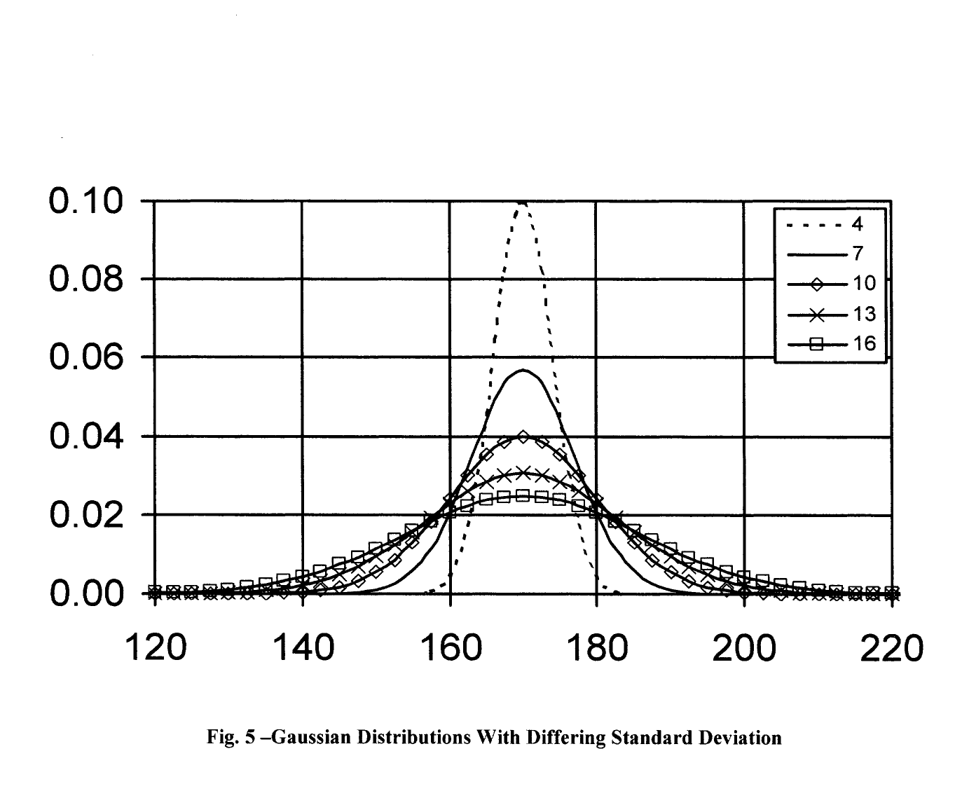

The mean value determines where the peak of the Gaussian PDF is located and the standard deviation determines the width of the peak. Since all Gaussian distributions are normalized a wider peak will also cause the peak to be lower in height. FIG. 5 shows the shape of several Gaussian distributions that have the same mean value but different standard deviations. It can be seen in FIG. 5 that as the standard deviation increases, the probability of the most likely value decreases. This is an important observation that will next be related to the Gaussangular distribution of this invention.

The notation in Equation (13) can be simplified by Equation (14) since these integrals are not solvable in a closed form and their solutions are usually found only in tabular form.

$$F ( x ) = P ( \frac{x - m}{σ} ) \qquad ( 14 )$$

However, it would be cumbersome to tabulate the possible values of F(x) for all permutations of x, m, and σ. One simplifying solution is to simply change the units of the exponent in Equation (13) by setting σ=1 and m=0 thereby creating a new specific CDF. This new variable is called z and is defined by Equations (15) and (16)

$$z = ( \frac{x - m}{σ} ) \qquad ( 15 )$$

and therefore

$$F ( z ) = P ( \frac{x - m}{σ} ) \qquad ( 16 )$$

these new units are called z-scores, or standard units, and tables for F(z) are available in handbooks and statistical texts for z≧0=m. Because of symmetry, the values for z<0 are not given.

Equation (17) is the integral of a symmetrical section of the CDF between the points (m−a) and (m+a).

$$A ( m + a ) = \frac{1}{σ \sqrt{2 π}} {\int }_{m - a}^{m + a} exp [ \frac{- {( x - m )}^{2}}{2 {σ}^{2}} ] \qquad ( 17 )$$

Using equation (17) and the symmetry of the Gaussian distribution, the normalization can be rewritten as equation (18)

2F(m−a)+A(m+a)=1 (18)

Equation (19) is obtained when Equation (14) is evaluated for x=m−a and combined with Equation (18).

$$2 P ( \frac{m - a - m}{σ} ) + A ( m + a ) = 1 \qquad ( 19 )$$

After solving Equation (19) for P(−a/σ) and using the identity P(−x)=1−P(x), Equation (20) is obtained.

$$P ( \frac{a}{σ} ) = \frac{1 + A ( m + a )}{2} \qquad ( 20 )$$

Once again the integral given by the left-hand side of Equation (20) can be obtained from handbooks and statistics texts.

If another constant, b, is defined as a=bσ, Equation (20) can be rewritten again in a more useful form of Equation (21).

$$P ( b ) = \frac{1 + A ( b )}{2} \qquad ( 21 )$$

where A(b) is the area under the PDF of Equation (10) between (m−bσ) and (m+bσ). The value of A(b) is plainly inversely related to the standard deviation, σ, of the PDF. Equation (21) will be important in relating the standard deviation of a Gaussian distribution to the effective standard deviation of a Gaussangular distribution.

### B.2. Symmetrical Gaussangular Distributions

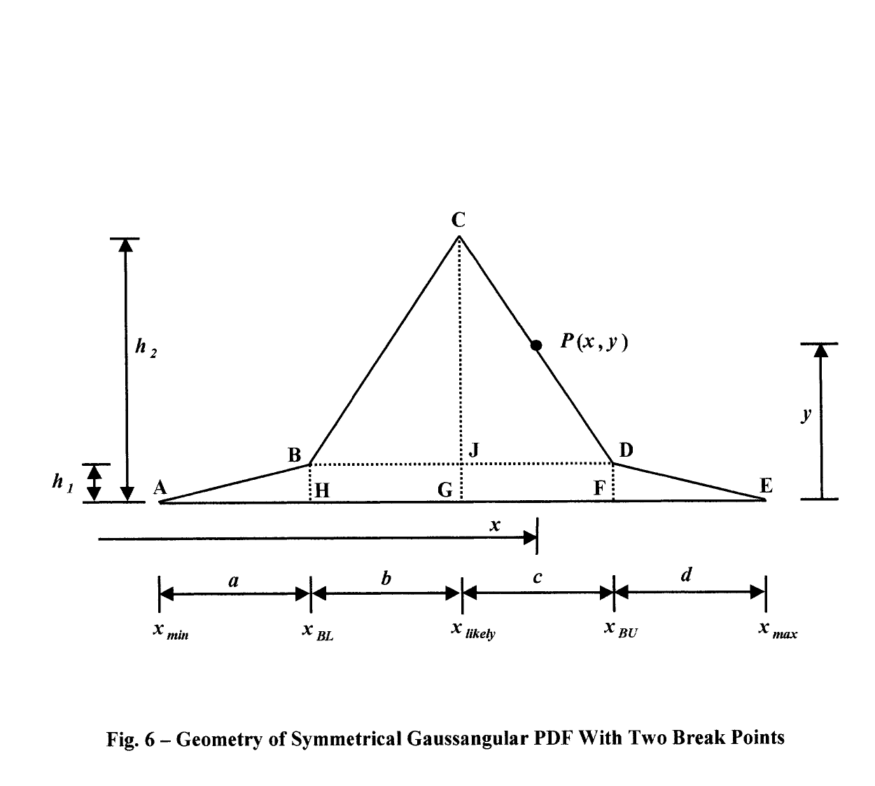

The symmetrical Gaussangular distribution with two break points is schematically represented in FIG. 6 and the line segment ABCDE is the PDF, p(x), of the Gaussangular distribution. Points B and D are called the “break points” of the distribution, and point C is the most likely value. There are no points outside the extrema (Points A and E) where the p(x)>0. In this symmetrical Gaussangular distribution, a=d and b=c. Depending on the data system being fit, a=kb and c=k′d, where k and k′ are constants that may have any value but are usually set to k=k′=1. The origin of this diagram is to the left and even with the base (line segment AE is on y=0) of the Gaussangular distribution. The following list is a summary of the geometrical considerations shown in FIG. 6.

a=|x_{BL}−xₘᵢₙ=AH

b=|x_{likely}−x_{BL}|=HG

c=|x_{BU}−x_{likely}|=GF

d=51 xₘₐₓ−x_{BU}|=FE

The areas under the different portions of the PDF (ABH, HBCJG, GJCDF, FDE) are determined using the simple plane geometry of FIG. 6.

$$\begin{matrix}{A}_{a} = \frac{a {h}_{1}}{2} & ( 22 ) \\ {A}_{b} = \frac{b ( {h}_{1} + {h}_{2} )}{2} & ( 23 ) \\ {A}_{c} = \frac{c ( {h}_{1} + {h}_{2} )}{2} & ( 24 ) \\ {A}_{d} = \frac{d {h}_{1}}{2} & ( 25 )\end{matrix}$$

Two other areas are defined in this invention to be:

A₁=Aₐ+A_{d} (26)

A₂=A_{b}+A_{c} (27)

and of course normalization requires:

A=A₁+A₂=1 (28)

The analysis of y=ƒ(x) will be deferred until the unsymmetrical Gaussangular distribution is discussed in Part B.5 of these specifications.

### B.3. Symmetrical Gaussangular Versus Gaussian Distribution

Recall that the area under a Gaussian PDF between (m−bσ) and m+bσ) is given by Equation (21) which can be rewritten as Equation (29) if A₂=A(b).

$$P ( b ) = \frac{1 + {A}_{2}}{2} \qquad ( 29 )$$

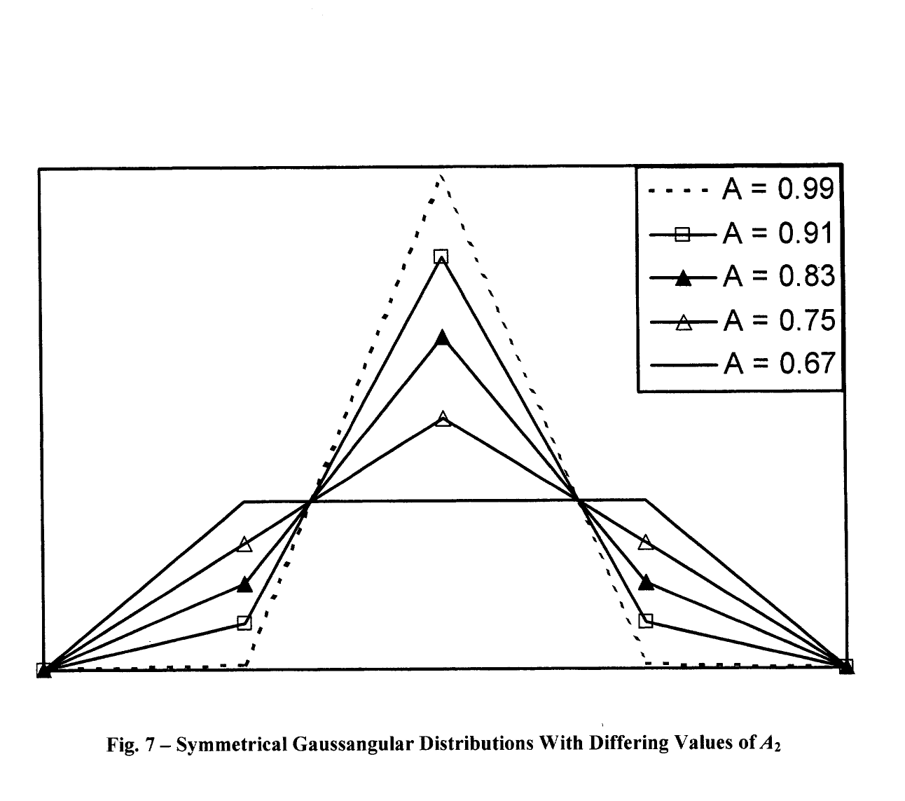

Next consider points defined by m±bσ as “break points” of the Gaussian distribution in a manner that is analogous to the break points of the Gaussangular distribution. Now the parameter of A₂ in equation (29) is equivalent to A₂=A_{b}+A_{c} of Equation (27) and it is inversely proportional to the Gaussian standard deviation. This can be seen in FIG. 7, which shows several Gaussangular PDF's with different values of A₂. The parameter A₂ is also a method to control the shape and character of the Gaussangular distribution.

A₂=0.67 is a “mesa-type” distribution

A₂=0.75 is a “triangular” distribution

A₂>0.67 are “Gaussian-type” distributions with varying standard deviations. The maximum amplitude of the PDF decreases and the “effective” standard deviation increases as the value of A₂ decreases. This is analogous to what is seen in FIG. 5.

The effective standard deviation of an unsymmetrical Gaussangular distribution, which will be derived in Part B.5, is also proportional to the inverse value of A₂.

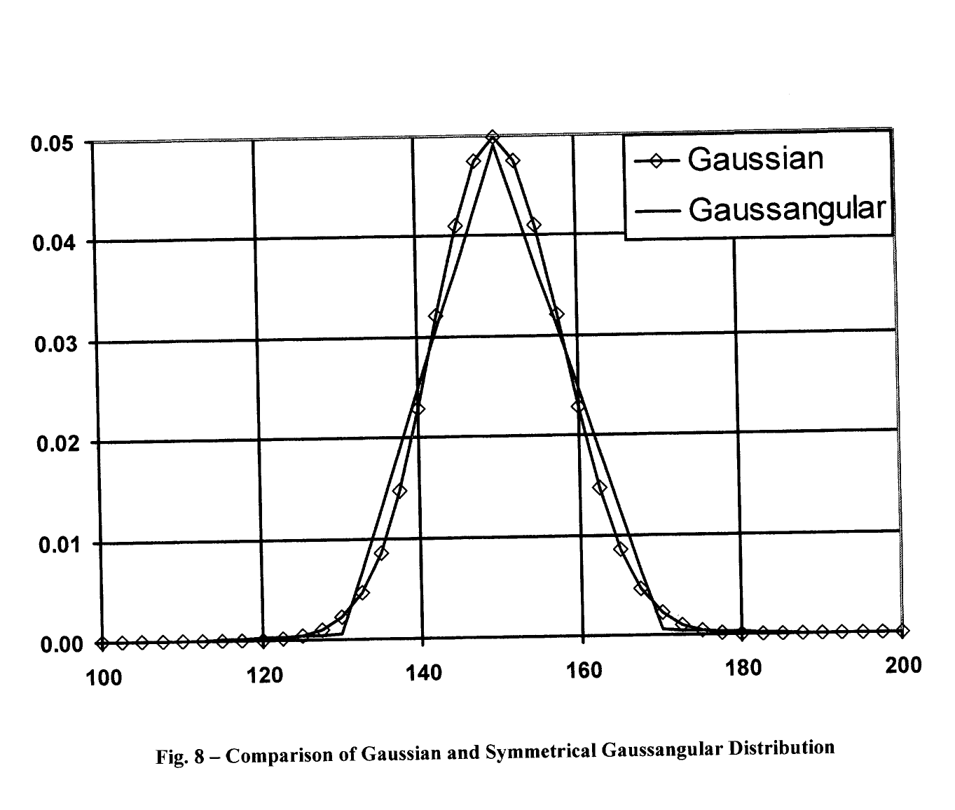

The quality of a fit of a Gaussangular distribution to Gaussian-type data in this invention can be seen in FIG. 8. The Gaussian distribution in FIG. 8 has m=150.0 and σ=8.0. In this particular embodiment of the invention, the following assumptions are made for the Gaussangular distribution in FIG. 8.

a=b=c=d=20

x_{likely}=150

A₂=0.99

In the embodiments of this invention, the value of the Gaussangular deviation variable, A₂, is set in a manner similar to how the standard deviation is used in calculations using Gaussian distributions.

### B.4. Gaussian, Triangular, and Gaussangular Distribution

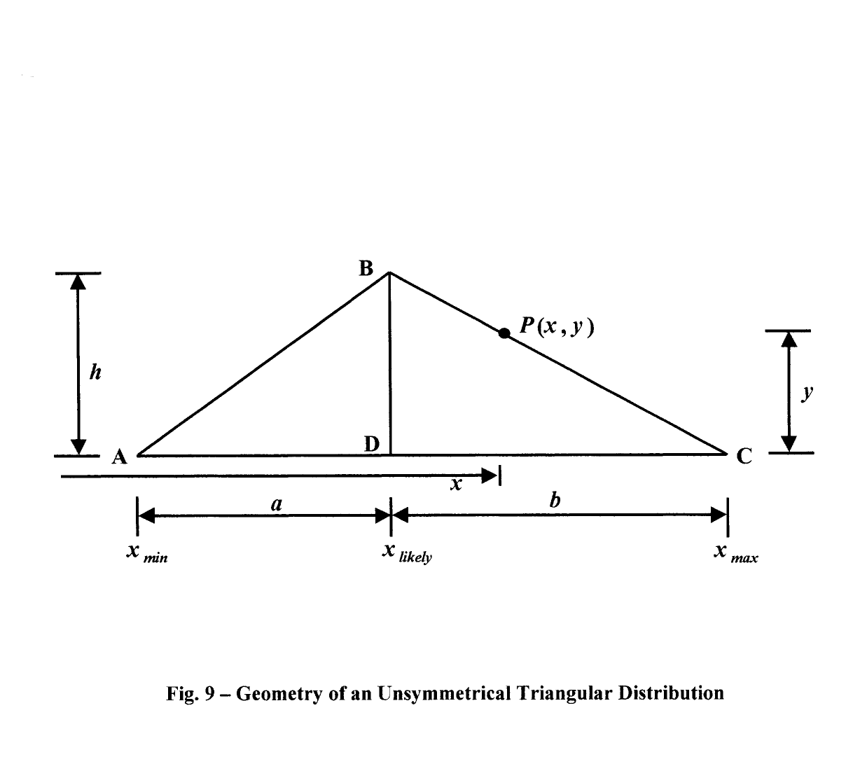

For reference purposes, FIG. 9 is a schematic diagram of the PDF for an unsymmetrical triangular distribution. The symmetrical Gaussangular distribution will become a symmetrical triangular distribution if the Gaussangular deviation variable A₂=0.75. This can be observed in FIG. 7. This can further be compared to Gaussian distributions shown in FIG. 5. If the xₘᵢₙ, x_{likely}, and xₘₐₓ are not changed, a Gaussangular distribution with A₂=0.99 is a good fit to a Gaussian distribution with a σ/m=0.0533 and a Gaussangular distribution with A₂=0.75 (this is a triangular distribution) is a good fit to a Gaussian distribution with σ/m=0.1067. All embodiments of this invention that use the Gaussangular distribution can therefore fit data that can be represented by either symmetrical or unsymmetrical Gaussian-type distributions, plus even the trivial triangular distributions. This inventor believes that the nature of the data found in business models requires the flexibility of the unsymmetrical bell-shape that is provided by the Gaussangular distribution. This invention most often utilizes Gaussangular distributions with 0.80≦A₂≦1.00, but can also be used to fit data with very large effective standard deviations by using 0.67≦A₂≦0.75.

### B.5. Unsymmetrical Gaussangular Distribution with Two Break Points

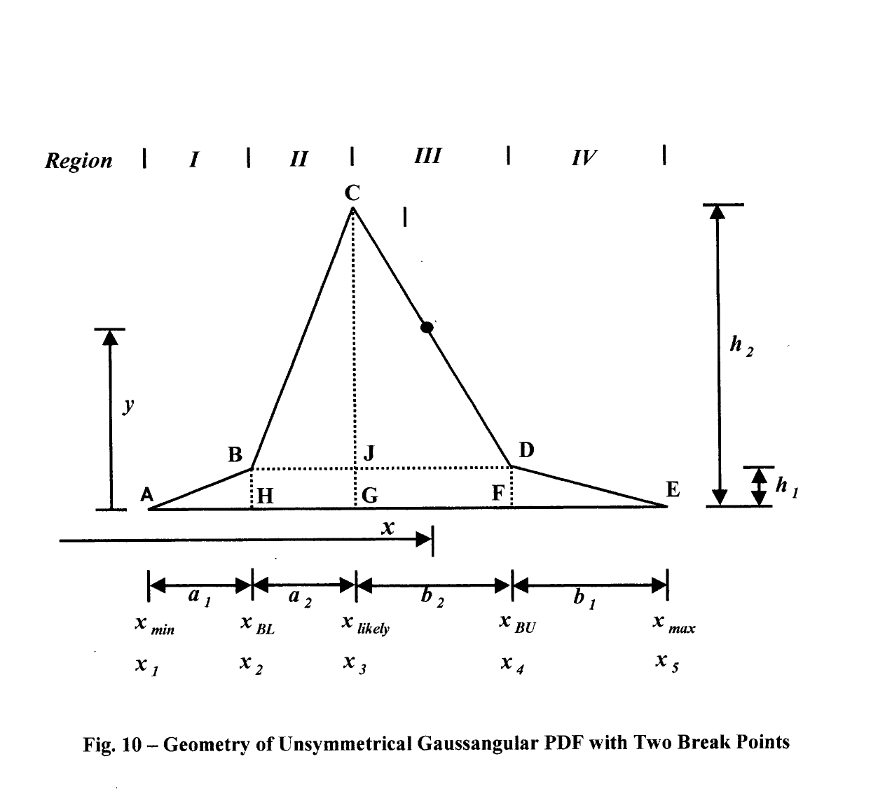

Several embodiments of this invention use an unsymmetrical Gaussangular distribution, or PDF, with two break points as shown in FIG. 10. The Gaussangular distribution is divided into the four regions I, II, II, and IV that are shown at the top of FIG. 10. The origin of this diagram is to the left and even with the base (line segment AE is on the axis y=0) of the Gaussangular distribution. Below is a summary of the characteristics of the PDF and CDF in each of these Regions. The CDF, F(x), for a data point in a particular region of FIG. 10 that is given below is defined by Equation (13). The areas for each region are also calculated.

### Region I (ABH in FIG. 10)

$${a}_{1} = \vert {x}_{2} - {x}_{1} \vert = \vert {x}_{BL} - {x}_{min} \vert = AH$$

$$\begin{matrix}F ( x ) = \frac{{( x - {x}_{1} )}^{2} {h}_{1}}{2 {a}_{1}} & ( 30 ) \\ {A}_{I} = \frac{{a}_{1} {h}_{1}}{2} & ( 31 )\end{matrix}$$

### Region II (HBCJG in FIG. 10)

$${a}_{2} = \vert {x}_{3} - {x}_{2} \vert = \vert {x}_{likely} - {x}_{BL} \vert = HG$$

$$\begin{matrix}F ( x ) = ( x - {x}_{2} ) {h}_{1} + \frac{{( x - {x}_{2} )}^{2} ( {h}_{2} - {h}_{1} )}{2 {a}_{2}} & ( 32 ) \\ {A}_{II} = \frac{{a}_{2} ( {h}_{1} + {h}_{2} )}{2} & ( 33 )\end{matrix}$$

### Region III (GJCDF in FIG. 10)

$$\begin{matrix}{b}_{2} = \vert {x}_{4} - {x}_{3} \vert = \vert {x}_{BU} - {x}_{likely} \vert = G F \\ F ( x ) = 1 - \frac{{b}_{1} {h}_{1}}{2} - ( {x}_{4} - x ) {h}_{1} + \frac{{( {x}_{4} - x )}^{2} ( {h}_{2} - {h}_{1} )}{2 {b}_{2}} & ( 34 ) \\ {A}_{III} = \frac{{b}_{2} ( {h}_{1} + {h}_{2} )}{2} & ( 35 )\end{matrix}$$

### Region IV (FDE in FIG. 10)

$$\begin{matrix}{b}_{1} = \vert {x}_{5} - {x}_{4} \vert = \vert {x}_{max} - {x}_{BU} \vert = FE \\ F ( x ) = 1 - \frac{{( {x}_{5} - x )}^{2} {h}_{1}}{2 {b}_{1}} & ( 36 ) \\ {A}_{IV} = \frac{{b}_{1} {h}_{1}}{2} & ( 37 )\end{matrix}$$

The following assumptions are valid in the four sets of calculations above.

A₁=A₁+A_{IV} (38)

A₂−A_{II}+A_{III} (40)

A_{T}=A₁+A₂=1 (41)

a₁=ka₂ (42a)

b₁=kb₂ (42b)

where the k in Equations (42a) and (42b) is an analyst-determined constant that may have any value but is usually k=1.

### B.6. Unsymmetrical Gaussangular Distribution with Four or More Breakpoints

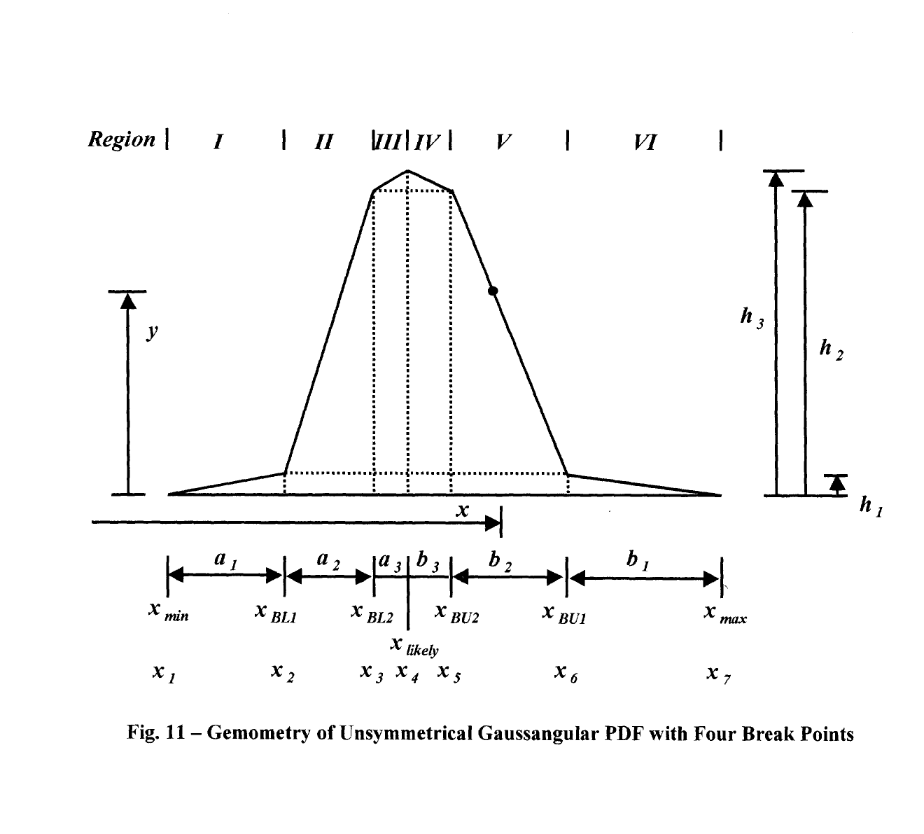

Different embodiments of this invention use the Gaussangular distribution that best fits the business input data and is most appropriate for the metric. One particular embodiment of this invention uses an unsymmetrical Gaussangular distribution, or PDF, with four break points as shown in FIG. 11. In this embodiment the Gaussangular distribution is divided into the six regions I, II, III, IV, V, and VI and they are noted at the top of FIG. 11. The origin of this diagram is to the left and even with the base (line segment AE is on the axis y=0) of the Gaussangular distribution. Below is a summary of the characteristics of the PDF and CDF in each of these Regions. By comparing FIG. 10 and FIG. 11, it can be seen the only difference between Gaussangular distributions with four break points compared with those with two break points is that two new regions (III and IV) are inserted into the middle of FIG. 11 with a maximum height of h₃. Further the Regions III and IV in FIG. 10 are the same as Regions V and VI in FIG. 11. The CDF, F(x), for a data point in a particular region of FIG. 11 that is given below is defined by Equation (13). The areas for each region are also calculated.

### Region I in FIG. 11

$$\begin{matrix}{a}_{1} = \vert {x}_{2} - {x}_{1} \vert = \vert {x}_{BL1} - {x}_{min} \vert \\ F ( x ) = \frac{{( x - {x}_{1} )}^{2} {h}_{1}}{2 {a}_{1}} & ( 43 ) \\ {A}_{1} = \frac{{a}_{1} {h}_{1}}{2} & ( 44 )\end{matrix}$$

### Region II in FIG. 11

$$\begin{matrix}{a}_{2} = \vert {x}_{3} - {x}_{2} \vert = \vert {x}_{BL2} - {x}_{BL1} \vert \\ F ( x ) = ( x - {x}_{2} ) {h}_{1} + \frac{{( x - {x}_{2} )}^{2} ( {h}_{2} - {h}_{1} )}{2 {a}_{2}} & ( 45 ) \\ {A}_{II} = \frac{{a}_{2} ( {h}_{1} + {h}_{2} )}{2} & ( 46 )\end{matrix}$$

### Region III in FIG. 11

$$\begin{matrix}{a}_{3} = \vert {x}_{4} - {x}_{3} \vert = \vert {x}_{likely} - {x}_{BL2} \vert \\ F ( x ) = {A}_{I} + {A}_{II} + ( x - {x}_{3} ) {h}_{2} + \frac{{( x - {x}_{3} )}^{2} ( {h}_{3} - {h}_{2} )}{2 {a}_{3}} & ( 47 ) \\ {A}_{III} = \frac{{a}_{3} ( {h}_{2} + {h}_{3} )}{2} & ( 48 )\end{matrix}$$

### Region IV in FIG. 1

$$\begin{matrix}{b}_{3} = \vert {x}_{5} - {x}_{4} \vert = \vert {x}_{BU2} - {x}_{likely} \vert \\ F ( x ) = 1 - {A}_{VI} - {A}_{V} - ( {x}_{5} - x ) {h}_{2} + \frac{{( {x}_{5} - x )}^{2} ( {h}_{3} - {h}_{2} )}{2 {b}_{3}} & ( 49 ) \\ {A}_{IV} = \frac{{b}_{3} ( {h}_{2} + {h}_{3} )}{2} & ( 50 )\end{matrix}$$

### Region V in FIG. 11

$$\begin{matrix}{b}_{2} = \vert {x}_{6} - {x}_{5} \vert = \vert {x}_{BU1} - {x}_{BU2} \vert \\ F ( x ) = 1 - {A}_{VI} ( {x}_{6} - x ) {h}_{1} + \frac{{( {x}_{6} - x )}^{2} ( {h}_{2} - {h}_{1} )}{2 {b}_{2}} & ( 51 ) \\ {A}_{V} = \frac{{b}_{2} ( {h}_{1} + {h}_{2} )}{2} & ( 52 )\end{matrix}$$

### Region VI in FIG. 11

$$\begin{matrix}{b}_{1} = \vert {x}_{7} - {x}_{6} \vert = \vert {x}_{max} - {x}_{BU1} \vert \\ F ( x ) = 1 - \frac{{( {x}_{7} - x )}^{2} {h}_{1}}{2 {b}_{1}} & ( 53 ) \\ {A}_{VI} = \frac{{b}_{1} {h}_{1}}{2} & ( 54 )\end{matrix}$$

The following assumptions are valid in the four sets of calculations above.

A₁=A_{I}+A_{VI} (55)

A₂=A_{II}+A_{III}+A_{IV}+A_{V} (56)

A_{T}=A₁+A₂=1 (57)

a₁=k(a₂+a₃) (58a)

b₁=k′(b₂+b₃) (58b)

where the k and k′ in Equations (58a) and (58b) are analyst-determined constants that may have any value but are usually k=k′=1.

a₂=ja₃ (59a)

b₂=j′b₃ (59b)

where the j and j′ in Equations (59a) and (59b) are analyst-determined constants that may have any value but are usually j=j′=3.

As has been previously noted, break points in sets of two can easily be added to the Gaussangular distribution in this invention. IT should also be noted that Some embodiments of this invention may use odd numbers greater than 1 (3,5, etc.) of break points. This section has discussed the changing of the Gaussangular distribution PDF from a two break point model to a four break point model. When changing the Gaussangular distribution PDF from a four break point model to a six break point model, only the two new middle regions, with a height of h₄ and widths of a₄ and b₄, need to be determined. In addition to defining these two new regions, additional restrictions will have to be placed on each of the a₁, and the A₁ and A₂ must be redefined. These decisions are always made by the analyst to provide the best fits to the business data used in the Monte Carlo risk analysis. As can now be seen, some embodiments of this invention may require adding break points if the data and metric require the added accuracy.

### C. The MCGRA Program

### C.1. Basic Logic Flow of the Software System (MCGRA)

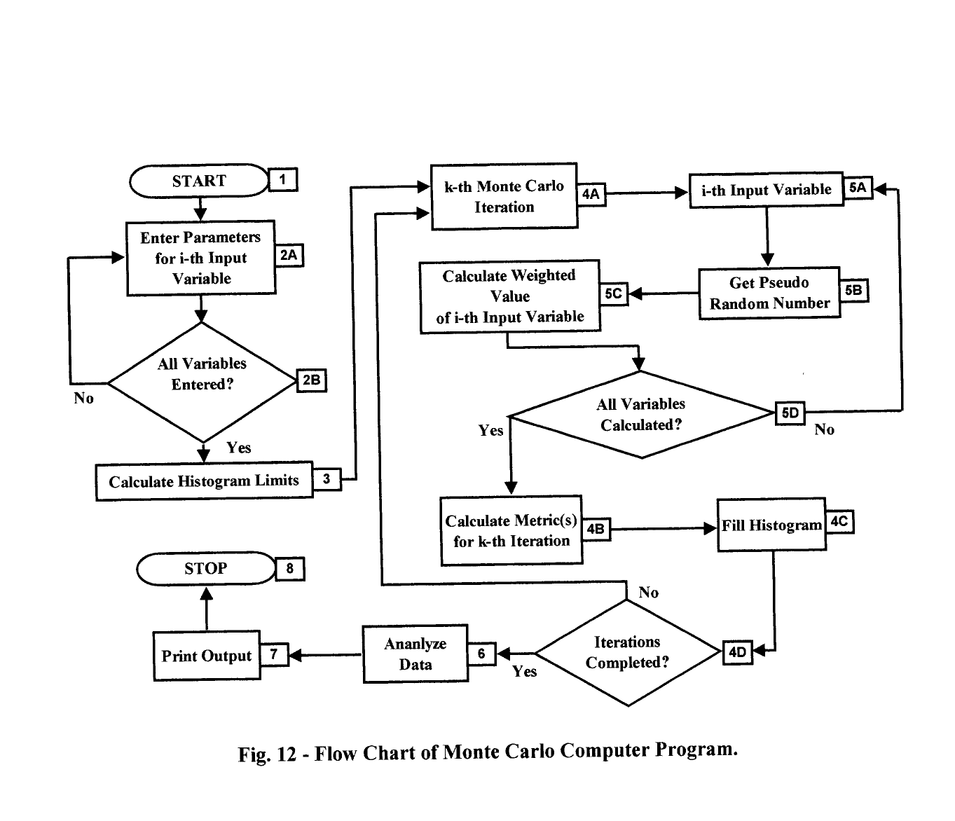

One embodiment of this invention is presented in the MCGRA computer software package that is a Visual Basic Macro for an Excel 97 worksheet and included with the invention. The general logic flow chart for this software is shown in FIG. 12. The metrics used in this particular embodiment are the pre-tax profit, after-tax cash flow and the profitability index to evaluate a 5-year pro forma. This embodiment has been used in the past to evaluate complex potential investments in the U.S. and less developed countries involving a wide variety of tax and partnership structures. The FIG. 12 is used below to help describe this invention.

### Step 1 of FIG. 12

This step starts the execution of the program. In MCGRA it is actually started by simultaneously pressing the ctrl-shift-M keys.

### Step 2A of Loop 2 in FIG. 12

Loop 2 includes Steps 2A and 2B in FIG. 12 and is the routine where the input variables are read into the memory. The actual variables to be input are determined by the metric used in the Monte Carlo risk analysis and in MCGRA these data are input using a structured Excel worksheet where each variable has a specific place. Once the Macro is started, the data are all read off this worksheet. Four values for each variable are required for each Monte Carlo variable. These are the absolute minimum, absolute minimum, and most likely values for each variable plus a value for the Gaussangular deviation variable, A₂, which is inversely proportional to the Gaussangular standard deviation. The data is then fit to a Gaussangular distribution for use in MCGRA.

### Step 2B of Loop 2 in FIG. 12

This step just makes ensures that all data is complete, ordered correctly (xₘᵢₙ≦x_{likely}≦xₘₐₓ), and have been read into the memory.

### Step 3 in FIG. 12

This is where the limits for each of the output histograms are calculated. The upper limit for the histogram is calculated using the maximum values of all additive factors (such as income-related items) and the minimum values of all factors (such as cost-related items) that decrease the net value if they are to be used in the numerator of an equation. This philosophy is reversed if the values are to be used in the denominator. The lower limit for the histogram is calculated using the minimum values of all additive factors (such as income-related items) and the maximum values of all factors (such as cost-related items) that decrease the net value if they are used in the numerator of an equation. Once again this philosophy is reversed if the values are to be used in the denominator. Once the upper and lower limit for the histogram of each output variable is known it is divided by 50 (the number of classes) to determine the class size. At this point the histogram structure for each of the output variables is fully defined.

### Step 4A of Loop 4 in FIG. 12

This step starts Loop 4 which is the main Monte Carlo iteration loop to calculate the k-th representative value of the metric(s), Hₖ(g_{i,k}), and it includes Steps 4A, 4B, 4C, and 4D plus Loop 5. Loop 5 determines the weighted values of each of the i-th input variables, g_{i,k} [see Equation (4)] to be used in this k-th iteration.

### Step 5A of Loop 5 in FIG. 12

This starts the Loop 5 by loading the set of parameters (xₘᵢₙ, x_{likely}, xₘₐₓ, and A₂) for a new (i-th) input variable, Gᵢ. These parameters will be used to construct a Gaussangular CDF for each of the Gᵢ.

### Step 5B of Loop 5 in FIG. 12

A PRN (pseudo random number) is obtained using a Congruential methodology with the next “seed.”

### Step 5C of Loop 5 in FIG. 12

The PRN is used with the Gaussangular CDF of the Gᵢ to obtain the weighted value g_{i,k}.

### Step 5D of Loop 5 in FIG. 12

This step checks to make sure a new and representative g_{i,k} has been calculated for each Gᵢ. If all have been calculated, Loop 5 is exited, otherwise the flow returns to Step 5A.

### Step 4B of Loop 4 in FIG. 12

A representative value of the metric Hₖ is calculated using the set of weighted values of g_{i,k} calculated in Loop 5, above.

### Step 4C of Loop 4 in FIG. 12

The output histograms are examined and the newly calculated representative value of Hₖ is placed in the proper class Hₖ(xₘ) by simply incrementing the appropriate class by one.

### Step 4D of Loop 4 in FIG. 12

If all iterations are complete, Loop 4 is exited by proceeding to Step 6, otherwise control flows to Step 4A.

### Step 6 in FIG. 12

This is the step where the output histogram(s) are analyzed. The first step of this analysis is to create a PDF by normalizing the histogram (which is a frequency distribution) and then creating the CDF. A series of calculations are then automatically performed and they are summarized in the list below.

1. The most likely value is determined.

2. The mean value is calculated.

3. The standard deviation of the distribution is calculated from the interpolated FWHM (full width half maximum) of the distribution.

4. The first value of each output variable is reported that has a calculated data point in the CDF that is less than 0.90.

5. The first value of each output variable is reported that has a calculated data point in the CDF that is less than 0.60.

6. The first value of each output variable is reported that has a calculated data point in the CDF that is less than 0.40.

The CDF of each output metric is available for plotting (it is on an Excel worksheet) and further analysis. Additional analyses that can be manually performed include the following.

The actual calculated data ranges for each output variable. This range is always smaller than the theoretical range calculated when the histograms were created in Step 3.

The probability that all of the risk capital will be returned over the term of the analysis.

The probability that the “profitability index” will have a value of at least 5 after five years and at least 3 after three years.

### Step 7 in FIG. 12

The output that is automatically printed includes the following for each metric for each year.

1. The most likely value.

2. The mean value.

3. The standard deviation of the distribution.

4. The first value of each output variable is reported that has a calculated data point in the CDF that is less than 0.90.

5. The first value of each output variable is reported that has a calculated data point in the CDF that is less than 0.60.

6. The first value of each output variable is reported that has a calculated data point in the CDF that is less than 0.40.

7. Tables for the PDF and CDF for each output variable for each year.

### Step 8 in FIG. 12

This step ends the execution of the program and transfers the user to the Output worksheet where further analyses can be performed on the CDF's and PDF's for each of output variables.

### C.2. Transformation from the Theory to the Software

The software constructed in this embodiment makes a complex process more understandable. Part of the complexity is due to the fact that people have never had to pay such close attention to the data for a pro forma analysis because a single “best” value for each input variable was all that was ever entered.

However, under the methodology required by this invention, sufficient data is required so the software can prepare a realistic probability distribution that can be readily and quickly used in the Monte Carlo risk analysis process. Further this embodiment of this invention provides information to the analyst that is not available in other methodologies and will truly lower the risk of doing business by providing high quality information that is generally not available to the business community.

### C.2.a. Input Data, Gaussangular Distributions, and Monte Carlo Output

The first priority of the Monte Carlo risk analysis process in this invention is to select the metric. When selecting the metric consideration should be given to that quality and amount of input data that is available or obtainable. Once the data is selected, four values must be provided for each input variable in order for a realistic distribution function to be created. Three of the four values are designed to be readily obtainable for various sources. These three values are the obtainable from various sources and are called the “keystone values” and they are listed below.

Absolute Minimum Value—This is the value below which there is no value.

Most Likely Value—This is the single “best guess” value that has been provided in the past when calculating business models.

Absolute Maximum Value—This is the value above which there is no value.

The final value that is required is that for A₂, which is inversely proportional to the “effective” standard deviation and it has possible values between 0.67 and 1.00. As the value of A₂ decreases the PDF peak will become wider and the shorter (see FIGS. 5 and 7). If a lot is known about the three keystone values then 0.98≦A₂≦0.99 are likely very good approximations for the year when data was developed. As the project is evaluated farther into the future, the value of A2 will certainly decrease, even as the values of the aᵢ and bᵢ of FIGS. 10 and 11 also increase. This is a realistic approach on how the distribution functions will be created from the available data.

The individual values of g_{i,k} are selected as shown in Equation (4) and Step 4a of the Table in FIG. 2. For the Gaussangular distribution this is accomplished by considering the region in which the g_{i,k} is located.

First consider FIG. 10 and Equations (30) through (42). The F(x) in the regional Equations (30), (32), (34), and (36) is equivalent to the F(x) in Equation (13) with the conditions that:

Equation (30) is only valid if x₁≦x<x₂ as shown in FIG. 10.

Equation (32) is only valid if x₂≦x≦x₃ as shown in FIG. 10.

Equation (34) is only valid if x₃≦x≦x₄ as shown in FIG. 10.

Equation (36) is only valid if x₄≦x≦x₅ as shown in FIG. 10.

Recall that the probability term, Pr{X≦x}, in Equation (13) has the domain defined by:

0≦[Pr{X≦x}=F(x)]≦1 (60)

Therefore there is a corresponding value of the PRN (0<PRN<1) for each value of xᵢ and this determines which of the Equations (30), (32), (34), and (36) will be used. Of course the solutions the solutions of Pr{X≦x₁}=0.00 and Pr{X≦x₅}=1.00 are trivial solutions. It also should be obvious that Equation (30) can only be used to solve for F(x) between x₁ and x₂; Equation (32) can only be used to solve for F(x) between x₂ and x₃; Equation (34) can only be used to solve for F(x) between x₃ and x₄; and Equation (36) can only be used to solve for F(x) between x₄ and x₅. These solutions will also provide the boundary values for Pr{X≦xᵢ}that allows the software to automatically determine which regional equation to use. This process is repeated for each of the input variables Gᵢ to obtain the g_{i,k} for this k-th iteration. It is important to note that a new PRN is required for each g_{i,k}.

This same process is used by embodiments of this invention when the Gaussangular distribution has four or more break points. In the case of four break points the regional equations for the F(x) are Equations (43), (45), (47), (49), (51), and (53).

It is important to digress a bit to remember that once the metric is selected, the values of the constant k in Equations (42a), (42b), (58a) and (58b) are set; and the constant j in Equations (59a) and (59b) are set in the software of this invention.

### C.2.b. Analysis of the Output Data Histogram

The output data, Hₖ, from the k-th iteration is a representative value of the metric calculated with weighted values of each of the metric's input values. The class boundaries are examined and the software determines which class contains this value of the Hₖ. This appropriate class is then incremented by one and iteration is complete. Therefore this output histogram is a tabular frequency distribution where the magnitude of each class represent the number of times, or frequency, a representative value of the metric, Hₖ, was calculated that fell within the class boundaries. This embodiment of the invention then transforms this frequency distribution into a tabular PDF by normalizing the raw data as shown in Equation (6). The tabular CDF is created from the PDF by using Equation (9) for the cases of n=1, . . . , m=50.

This embodiment of the invention determines the most likely value of the distribution by performing a weighted interpolation of the three point probabilities with the largest values. Next the mean is calculated using Equation (7) and the standard deviation is calculated using Equation (8). This embodiment of the invention then selects three values of xₙ from the tabular CDF that may be useful to the analyst. These three values are for the xₙ where Pr{X≦xₙ}<0.9, 0.6, and 0.4. Since this embodiment of the invention provides the tabular PDF and CDF for each metric for each year on an Excel worksheet, a multitude of other analysis can also be manually performed.

Obviously, numerous variations and modifications can be made without departing from the spirit of the present invention. Therefore, it should be clearly understood that the form of the present invention described above and shown in the figures and tables of the accompanying drawings is illustrative only and is not intended to limit the scope of the present invention.

What is claimed:

1. A stochastic process for simulating on a computer or computer system the behavior and consequences of a scenario, the process comprising:
a) using a metric, either static or dynamic, that realistically simulates the scenario being modeled;
b) using distribution functions, either symmetrical or unsymmetrical, that best describe the available data for each of the input variables of the metric used to simulate the scenario;
c) performing enumerable iterations, wherein a new numeric solution to the metric is calculated in each iteration by selecting new values for each input variable within its distribution by using a new pseudo-random number and the probability distribution function for that input variable;
d) placing each of the enumerable solutions to the metric from each iteration into a discrete frequency distribution;
e) converting the discrete frequency distribution into a discrete probability distribution; and
f) using the discrete probability distribution for the metric to analyze the scenario predicted by the metric by calculating parameters comprising the mean value of the metric, the most likely value of the metric, the probability the metric will have at least a certain value, the probability the metric will be more than at least a certain value, and the probability that the metric will lie between certain bounds.

2. The process described in claim 1, wherein said scenarios are business investments the possible metrics for each year is determined by the user but can comprise such evaluations as discounted cash flows, profitability index, pre-tax profit, and after-tax cash flows.

3. The process described in claim 1, wherein said scenarios are the future behavior of an existing business the possible metrics for each year is determined by the user but can comprise such evaluations as discounted cash flows, profitability index, pre-tax profit, and after-tax cash flows.

4. The process described in claim 1, wherein the said stochastic process used may be also known as the Monte Carlo simulation method which uses a distribution function to represent each input variable in the metric and the end result of the calculational process is a discrete distribution representing the metric.

5. A process for creating on a computer or computer system an angular approximation to a continuous PDF (probability density function), p(x), the process comprising:
a) using the minimum value of x, xₘᵢₙ, and the maximum value of x, xₘₐₓ to define the boundaries of the PDF where the p(x)=0;
b) using the most likely value of x, x_{likely}, to define the point where p(x) is at a maximum;
c) using break points to be those points where any two straight-line segments intersect at an angle not equal to zero degrees (0°) including at x_{likely};
d) using a series of straight-line segments that run consecutively from xₘᵢₙ to the first break point, then continuing from break point to break point, and ending from the last break point to xₘₐₓ;
e) associating the inverse of the area between one break point near xₘᵢₙ and one break point near xₘₐₓ to represent the effective standard deviation which is proportional to the square of the second central moment of the Gaussangular distribution;
f) whereas the angular approximation may be either symmetrical or unsymmetrical with respect to the distances |xₘₐₓ−x_{likely}| and |x_{likely}−xₘᵢₙ|;
g) whereas the angular approximation may be either symmetrical or unsymmetrical with respect to the lengths of the line segments in the approximation; and
h) whereas the approximation to the continuous probability density function is a mathematical function comprising the variables xₘᵢₙ, x_{likely}, xₘₐₓ, and the break points;

6. The process described in claim 5, wherein said approximation can represent symmetrical or unsymmetrical triangular or mesa-type distributions.

7. The process described in claim 5, wherein said approximation can represent Gaussian or normal distributions or unsymmetrical bell-shaped distributions.
